(19) United States
(12) Patent Application Publication
(10) Pub. No.: US 2006/0048609 A1
(43) Pub. Date: Mar. 9, 2006

(54) Ratchet wrench adapted to operate with a different wrench

(76) Inventor: Leo Shih, Taichung (TW)

Correspondence Address: LAW OFFICE OF LIAUH & ASSOC., 4224 WAIALAE AVE, STE 5-388, HONOLULU, HI, 96816, US

(21) Appl. No.: 10/938,345

(22) Filed: Sep. 9, 2004

(51) Int. Cl. B25B 13/46; B25B 23/16; B25G 1/00

(52) U.S. Cl. 81/60; 81/177.85; 81/177.9

(57) ABSTRACT

An improved ratchet wrench is provided. In one embodiment, the ratchet wrench comprises a pawl and a square drive tang both at one end, an enclosed square box portion at the other end, the box portion being adapted to connect to a drive tang at a ratcheting end of a second typical longer wrench. The drive tang of the ratchet wrench receives in a drive opening of a socket which has its driving end engaged with a nut or bolt head such that torquing is provided thereto by turning the second wrench. In another embodiment, the drive tang of the ratchet wrench is replaced by a cylindrical socket adapted to receive a nut or bolt head. The invention is particularly suitable to a narrow working circumstance.

### FIELD OF THE INVENTION

The present invention relates to ratchet wrenches and more particularly to such a ratchet wrench being connectable to a different, preferably longer wrench for being adapted to a different working circumstance when used with each other.

### BACKGROUND OF THE INVENTION

Conventionally, ratchet wrench is classified as a socket ratchet wrench and a ratchet wrench having a drive tang. Either is further classified as a long one, a short one, etc. For the ratchet wrench having a drive tang, it is classified as a long one, a short one, and a special one, each will be described in detailed below.

A conventional short ratchet wrench having a drive tang is shown in FIG. 1. As shown, the wrench comprises a short handle 1, a pawl 2 at one end of the handle 1, and a square drive tang 3 extended downward from the pawl 2. In use, insert the drive tang 3 into a square drive opening of a socket 4 which has the other end coupled to a working piece (e.g., nut or bolt head). This prior ratchet wrench is particularly suitable for operating in a narrow environment where a access is difficult.

Another conventional long ratchet wrench having a drive tang is shown in FIG. 2. As shown, the wrench comprises an elongate handle 5, a pawl 6 at one end of the handle 5, and a square drive tang 7 extended downward from the pawl 6. In use, insert the drive tang 7 into a square drive opening of a socket 8 which has the other end coupled to a working piece (e.g., nut or bolt head). This prior ratchet wrench is a general type not suitable for operating in a narrow environment.

A further conventional special ratchet wrench having a drive tang is shown in FIG. 3. As shown, the wrench comprises a handle 10, a wrench head 9, a pawl 11 at the wrench head 9, and a square drive tang 12 extended downward from the wrench head 9. A plurality of apertures 13 are arranged as an arc and are formed at one end coupled to a projection of the wrench head 9. Two pegs 14 are formed on the projection. In use, insert the pegs 14 into the apertures 13. Also, the pegs 14 are adapted to insert into a pair of apertures 13 different from a previous arrangement so as to adjust itself (i.e., angle of the handle 10) to a special working circumstance, for example, repairing an automobile engine as shown in FIG. 4. This prior ratchet wrench is particularly suitable for operating in a special circumstance.

But all of the above are unsatisfactory for the purpose for which the invention is concerned for the following reasons: It is impossible of connecting two of them to use (i.e., use with each other being impossible). Typically, a user has to buy all of the above ratchet wrenches such that the user can work in any one of many different working conditions when use of one of the ratchet wrenches is required. This inevitably will increase the financial burden borne on the user. Also, carrying all of the above ratchet wrenches is a cumbersome, laborious work. Moreover, only several insertion choices (i.e., the pegs 14 inserted into the apertures 13) are available for the special ratchet wrench. Hence, the angle adjustment of the handle is limited. This can limit applications. Thus, the need for improvement still exists.

### SUMMARY OF THE INVENTION

It is an object of the present invention to provide a ratchet wrench, comprising a pawl disposed at one end; a drive tang extended downward from the pawl; an enclosed box portion disposed at the other end, wherein the box portion is operative to connect to a drive tang of a longer second wrench selected from a plurality of different wrenches including ratchet wrenches, and the drive tang of the ratchet wrench is operative to receive in a drive opening of a socket which has its driving end engaged with a working piece such that torquing is provided to the working piece by turning the second wrench. The present invention is particularly suitable to a narrow working circumstance when used with the second wrench. Moreover, by utilizing the present invention, the financial burden borne on users of buying many unnecessary tools is eliminated. Also, the present invention can operate conveniently.

It is another object of the present invention to provide a ratchet wrench, comprising a pawl disposed at one end; a socket formed in an inner surface of an opening at end; and an enclosed box portion disposed at the other end, wherein the box portion is operative to connect to a drive tang of a longer second wrench selected from a plurality of different wrenches including ratchet wrenches, and the socket is operative to engage with a working piece such that torquing is provided to the working piece by turning the second wrench.

In one aspect of the present invention, labor is saved when the ratchet wrench of the present invention is used with the longer second wrench (e.g., a ratchet wrench).

In another aspect of the present invention, the longer second wrench (e.g., a ratchet wrench) can be set at an angle with respect to the ratchet wrench of the present invention in an operating position.

The above and other objects, features and advantages of the present invention will become apparent from the following detailed description taken with the accompanying drawings.

### BRIEF DESCRIPTION OF THE DRAWINGS

FIG. 1 is a perspective view of a conventional short ratchet wrench having a drive tang to be connected to a socket;

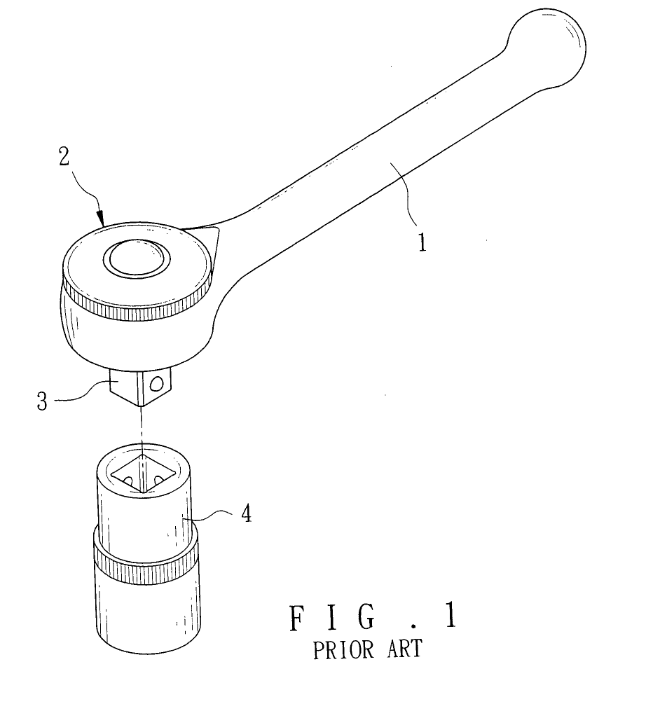

FIG. 2 is a perspective view of a conventional long ratchet wrench having a drive tang to be connected to a socket;

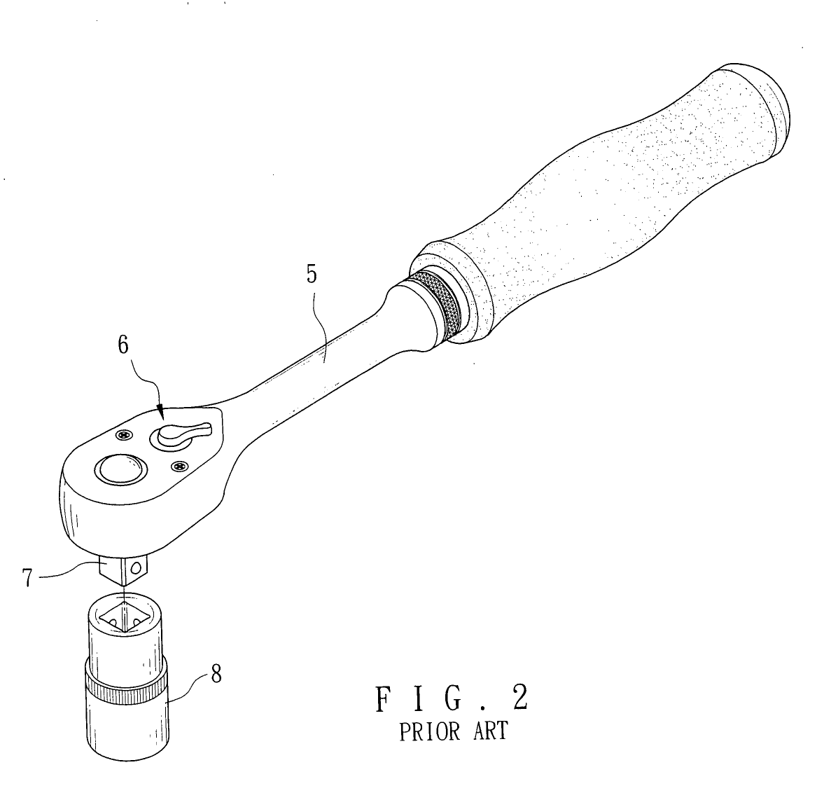

FIG. 3 is a perspective view of a conventional special ratchet wrench having a drive tang to be connected to a socket;

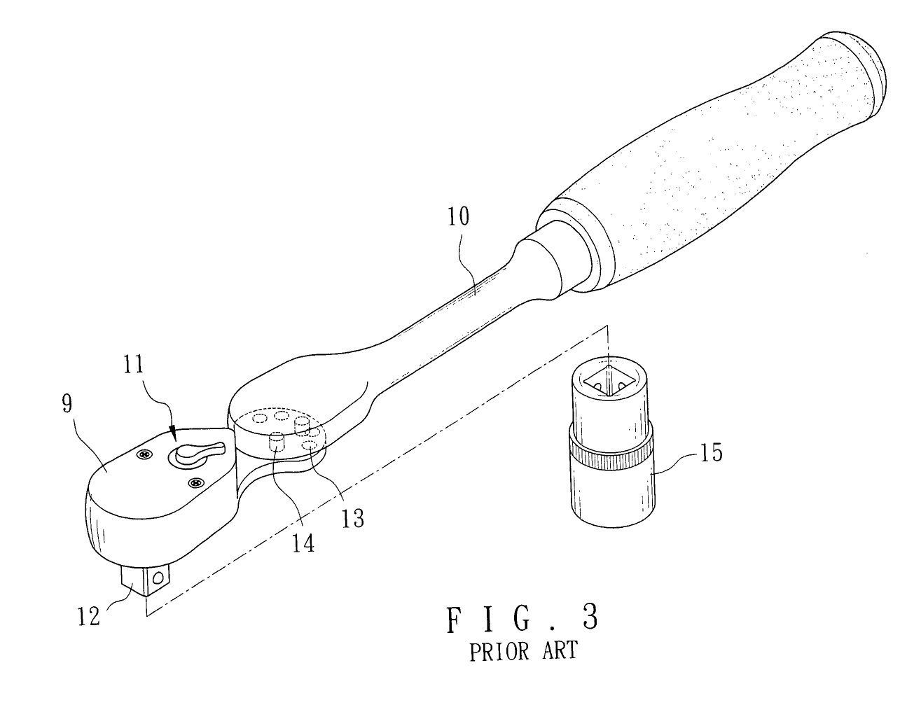

FIG. 4 is a top view of the special wrench and the socket of FIG. 3 in an operating position;

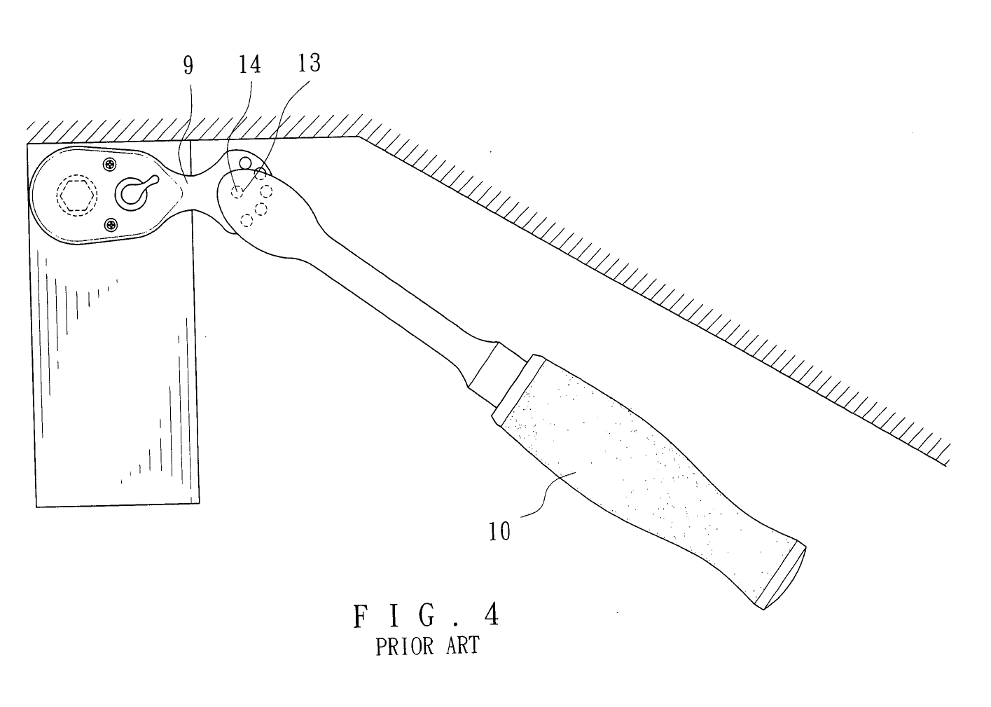

FIG. 5 is a perspective view of a first preferred embodiment of ratchet wrench according to the invention;

FIG. 6 is a perspective view of the wrench of FIG. 5, the wrench having a drive tang at one end to be connected to a socket and an enclosed square box portion the other end to be connected to a drive tang of either a long ratchet wrench or a long wrench;

FIG. 7 is an environmental view of the assembled ratchet wrench of the invention, socket, and long ratchet wrench shown in FIG. 6 prior to holding and turning a bolt head;

FIG. 8 is a top view of the positioned components shown in FIG. 7 where the long ratchet wrench is at an angle with respect to the ratchet wrench of the invention in an operating position ;

FIG. 9 is a view similar to FIG. 8 where the reversing lever of the pawl is switching to set an angle of the long ratchet wrench with respect to the ratchet wrench of the invention;

FIG. 10 is a view similar to FIG. 9 where the angle has been set and the long ratchet wrench is turning clockwise to turn the ratchet wrench of the invention and thus the bolt;

FIG. 11 is a view similar to FIG. 8 where the reversing lever has been switched to the position shown in FIG. 8 and then the long ratchet wrench is able to turn counterclockwise in a returning operation;

FIG. 12 is another top view of the positioned components shown in FIG. 7 where the long ratchet wrench and the ratchet wrench of the invention are turning clockwise in an operating position; and

FIG. 13 is a perspective view of a second preferred embodiment of ratchet wrench according to the invention to be connected to a long ratchet wrench.

### DETAILED DESCRIPTION OF THE PREFERRED EMBODIMENTS

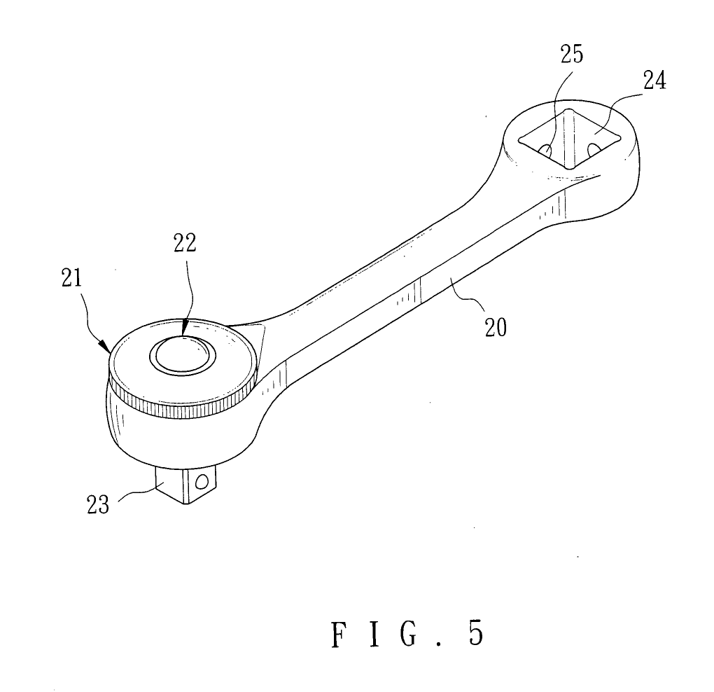

Referring to FIG. 5, there is shown a ratchet wrench 20 constructed in accordance with a first preferred embodiment of the invention. The ratchet wrench 20 of the invention is implemented as a short one and comprises a pawl 21 and a quick release mechanism 22 both at one end, a square drive tang 23. extended downward from one end, an enclosed square box portion 24 at the other end, and two detent apertures 25 on an inner surface of the box portion 24. Note that both the pawl 21 and the quick release mechanism 22 are prior art.

Thus, a detailed description thereof is omitted herein for the sake of brevity.

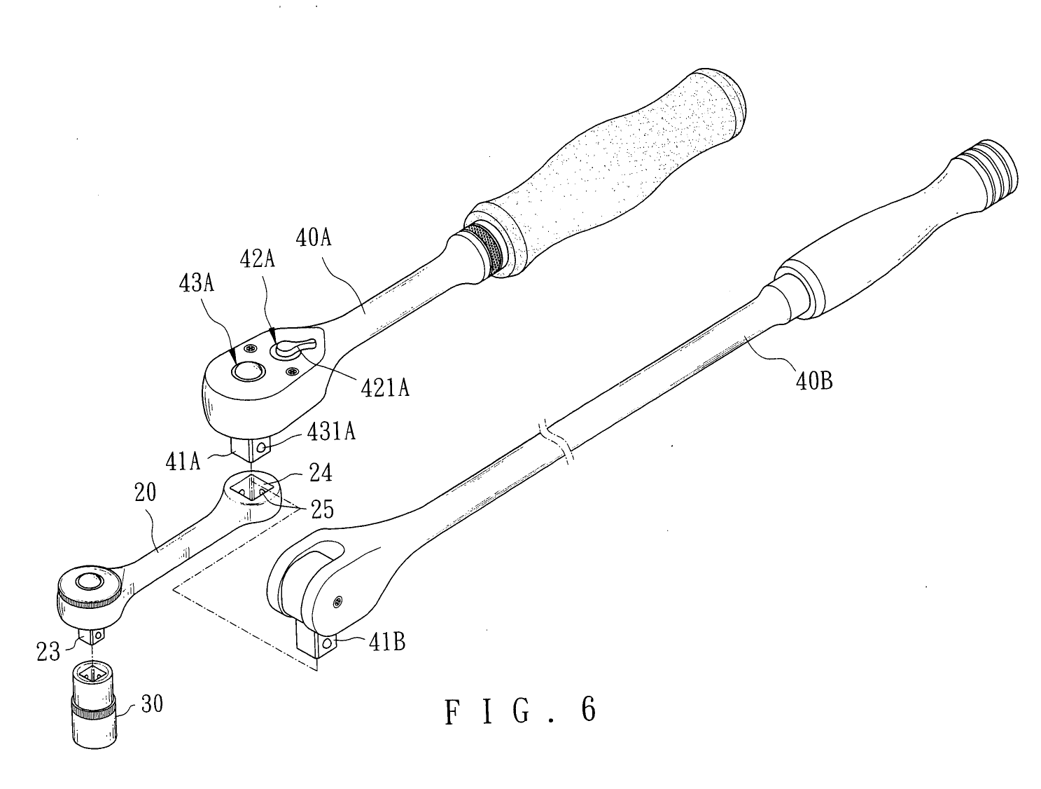

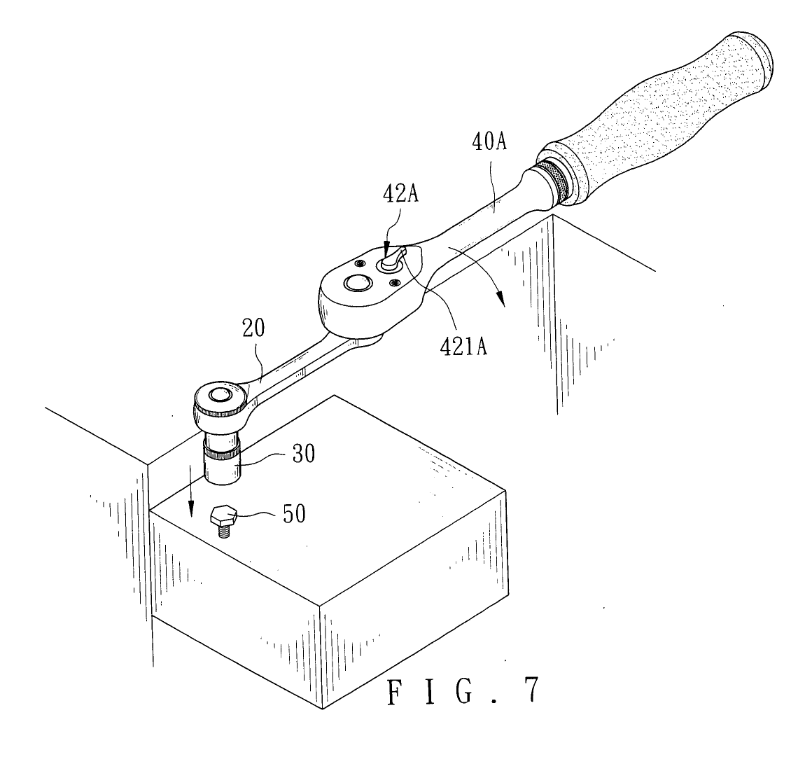

Referring to FIGS. 6 and 7, the drive tang 23 is adapted to receive in a square drive opening of a socket 30. A square drive tang 41A is extended downward from one end of a long ratchet wrench 40A which is taken as an exemplary example of the invention. The drive tang 41A has two spring depressible balls (i.e., detents) 431A on its opposite sides. As such, after snapping the drive tang 41A into the box portion 24, the long ratchet wrench 40A and the ratchet wrench 20 of the invention are secured together due to the mated engagement of the detents 431A and the detent apertures 25. This forms a combinative ratchet wrench with the long ratchet wrench 40A used a handle.

The long ratchet wrench 40A further comprises a pawl 42A having a reversing lever 421A, and a quick release mechanism 43A. Note that the pawl 42A, the reversing lever 421, and the quick release mechanism 43A are prior art. Thus, a detailed description thereof is omitted herein for the sake of brevity. Alternatively, a square drive tang 41B of a long wrench 40B is adapted to receive in the box portion 24 to couple together prior to operating. But it will not be described further for the sake of brevity.

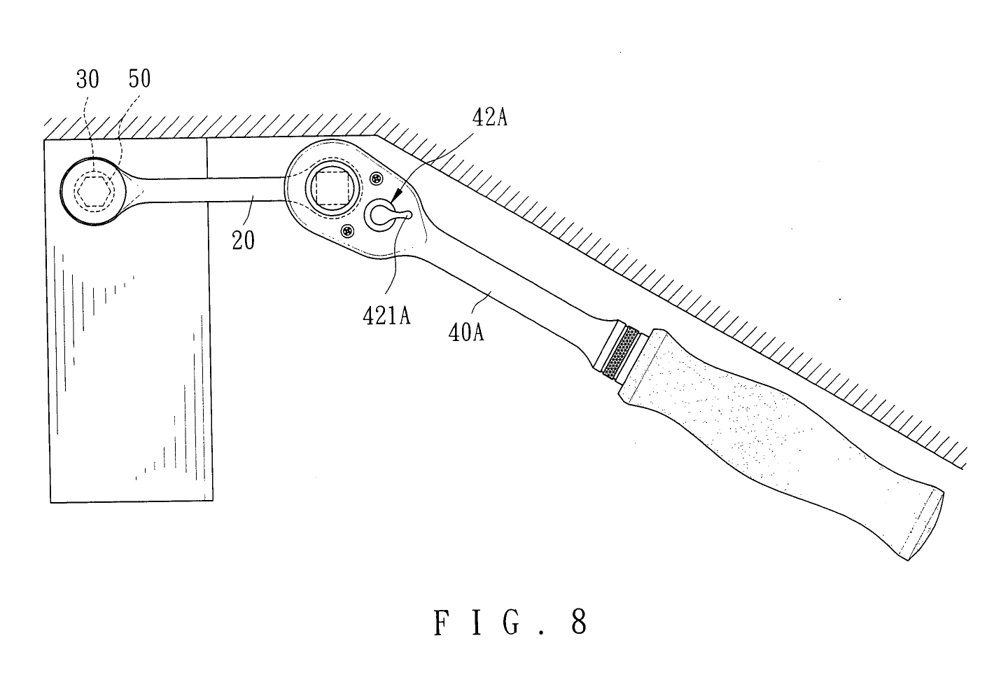

Referring to FIG. 8 in conjunction with FIG. 7, the pawl 42A is designed to turn clockwise to a neutral position after moving the reversing lever 421A to a desired position. Thus, the long ratchet wrench 40A then turns clockwise (i.e., neutral) for enabling the ratchet wrench 20 of the invention to set its angle with respect to the long ratchet wrench 40A prior to being adapted to a different working circumstance when used with each other. As shown, the socket 30 has its driving end being engaged with a bolt head 50 to be torqued.

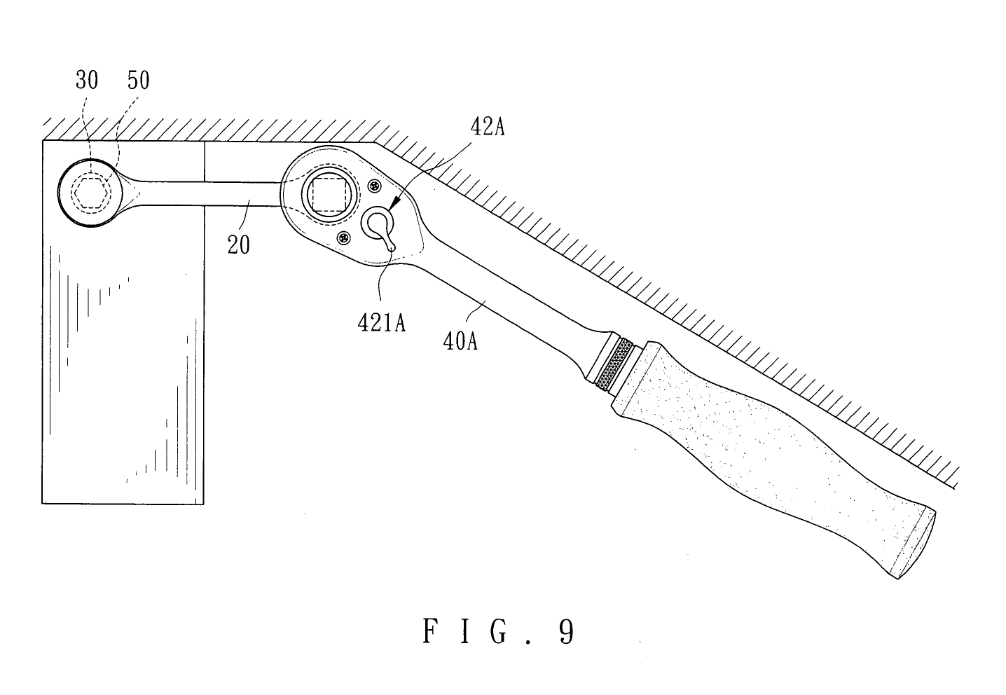

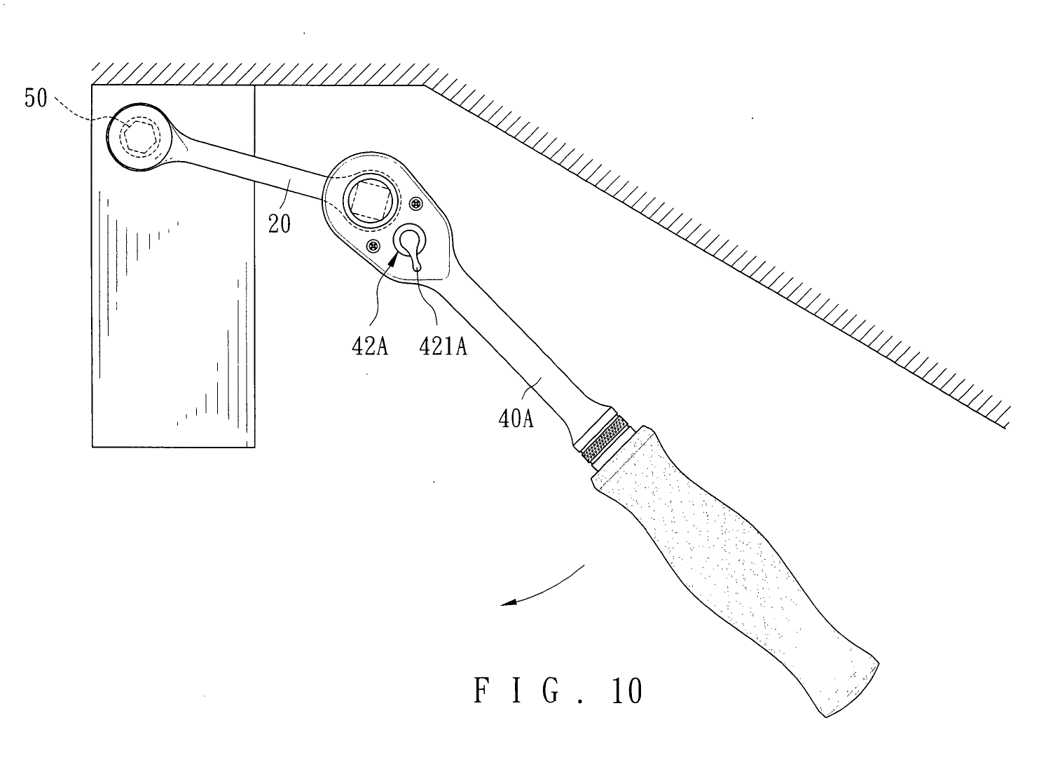

Referring to FIGS. 9 and 10, turn the reversing lever 421A clockwise to set an angle between the long ratchet wrench 40A and the ratchet wrench 20 of the invention. Next, turn the long ratchet wrench 40A clockwise and thus the ratchet wrench 20 of the invention to torque the bolt head 50 for fastening.

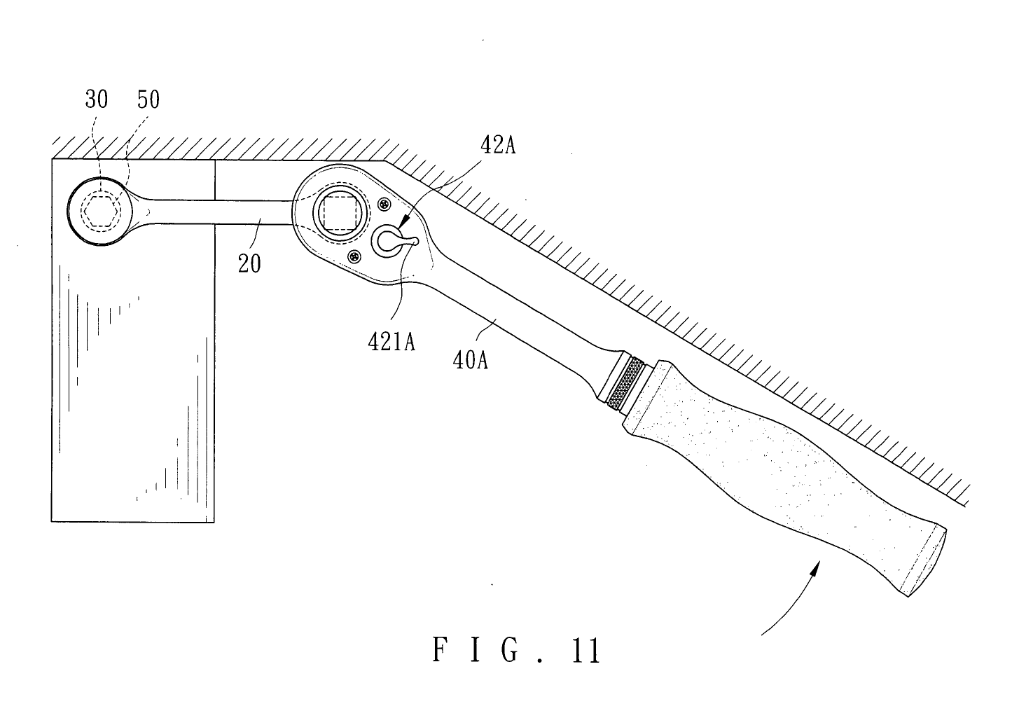

Referring to FIG. 11, for preventing the long ratchet wrench 40A from entering a neutral position and thus changing the set angle when it turns counterclockwise to return to its original position, it may counterclockwise turn the reversing lever 421A to set a counterclockwise rotation as the direction of force exertion. Hence, a subsequent counterclockwise turning of the long ratchet wrench 40A will also counterclockwise turn the ratchet wrench 20 of the invention without changing the set angle. The operations illustrated from FIGS. 8 to 11 can be repeated a plurality of times for fastening the bolt head 50.

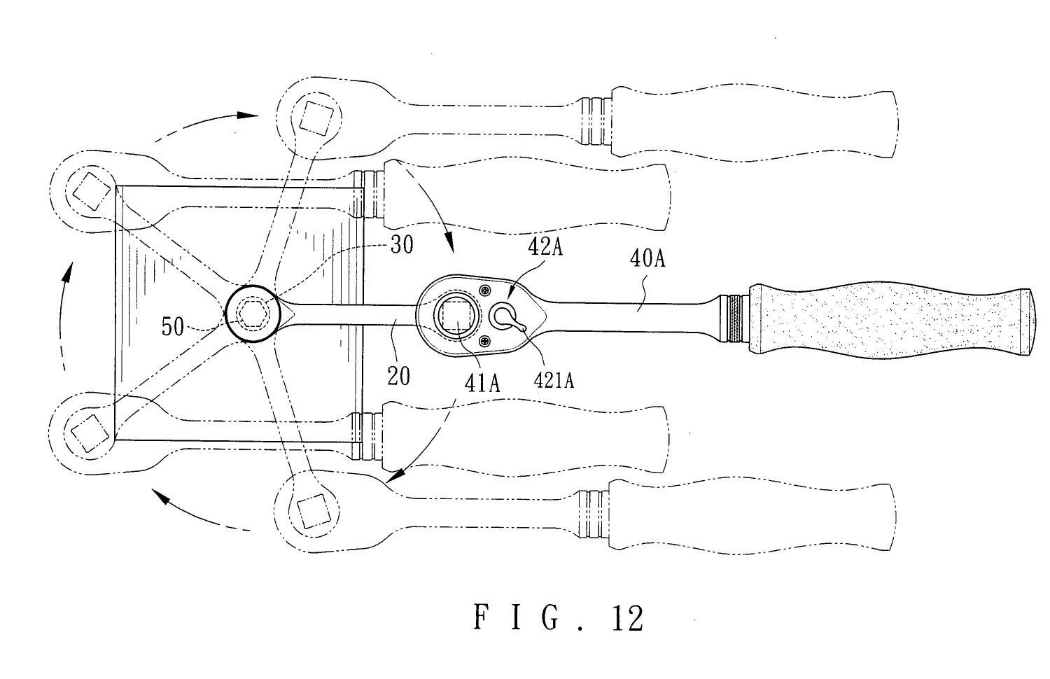

Referring to FIG. 12, a clockwise turning of the ratchet wrench 20 of the invention is set as a force exertion operation. Thus, turn the reversing lever 421A to set a clockwise rotation of the drive tang 41A as a neutral operation.

Next, a clockwise rotation of the long ratchet wrench 40A can clockwise turn the ratchet wrench 20 of the invention with respect to the socket 30 with the drive tang 41A being neutral while the pawl 42A is turning clockwise. As such, the ratchet wrench 20 of the invention turns clockwise to quickly fasten the bolt 50.

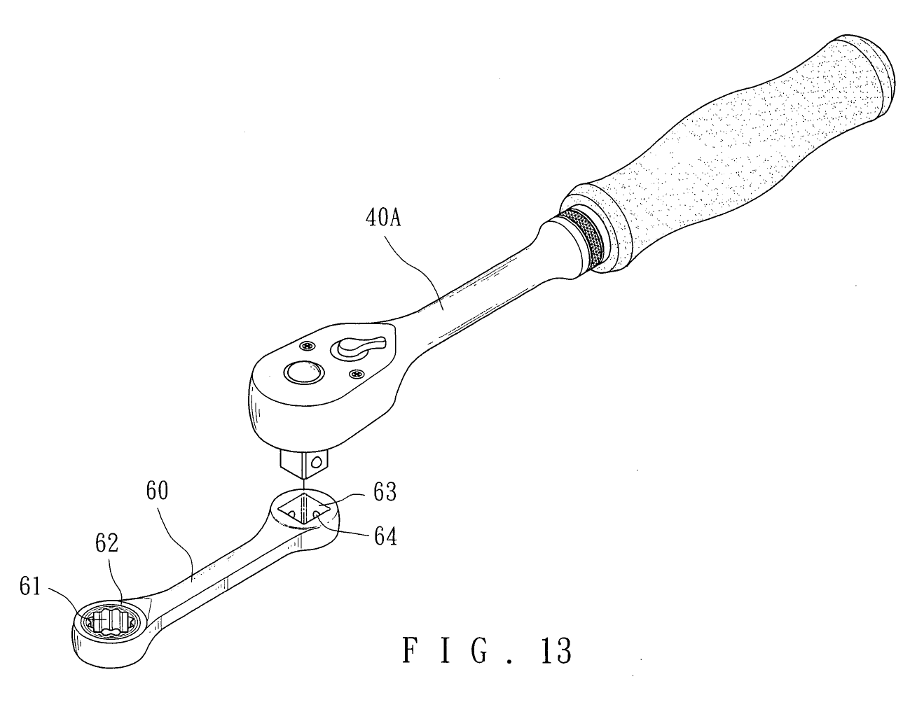

Referring to FIG. 13, there is shown a ratchet wrench 60 constructed in accordance with a second preferred embodiment of the invention. The characteristics of the second preferred embodiment are detailed below. One end of the ratchet wrench 60 of the invention is configured as a ratcheting end (e.g., a pawl 62). A cylindrical socket 61 is formed in an inner surface of a cavity in the ratcheting end 61. The socket 61 is adapted to engage with a bolt head or nut. The other end of the ratchet wrench 60 of the invention is configured as an enclosed square box portion 63 having two detent apertures 64 on its inner surface. The box portion 63 is adapted to matingly couple to a drive tang of a long ratchet wrench 40A for being able to operate in a special working circumstance when used with each other.

While the invention herein disclosed has been described by means of specific embodiments, numerous modifications and variations could be made thereto by those skilled in the art without departing from the scope and spirit of the invention set forth in the claims.

What is claimed is:

1. A ratchet wrench, comprising:
a pawl disposed at one end;
a drive tang extended downward from the pawl;
an enclosed box portion disposed at the other end,
wherein the box portion is operative to connect to a drive tang of a second wrench selected from a plurality of different wrenches, and the drive tang of the ratchet wrench is operative to receive in a drive opening of a socket which has its driving end engaged with a working piece such that torquing is provided to the working piece by turning the second wrench.

2. The ratchet wrench of claim 1, wherein the box portion has a square section.

3. The ratchet wrench of claim 2, further comprising at least one pair of opposite detent apertures disposed on the square inner surface of the box portion.

4. The ratchet wrench of claim 1, wherein the drive tang of the ratchet wrench has a square section.

5. A ratchet wrench, comprising:
a pawl disposed at one end;
a socket formed in an inner surface of an opening at end; and
an enclosed box portion disposed at the other end,
wherein the box portion is operative to connect to a drive tang of a second wrench selected from a plurality of different wrenches, and the socket is operative to engage with a working piece such that torquing is provided to the working piece by turning the second wrench.

6. The ratchet wrench of claim 5, wherein the box portion has a square section.

7. The ratchet wrench of claim 6, further comprising at least one pair of opposite detent apertures disposed on the square inner surface of the box portion.

8. The ratchet wrench of claim 5, wherein the socket is cylindrical.
